(19) United States
(12) Patent Application Publication
(10) Pub. No.: US 2010/0107009 A1
(43) Pub. Date: Apr. 29, 2010

(54) DETERMINISTIC COMPONENT MODEL JUDGING APPARATUS, JUDGING METHOD, PROGRAM, RECORDING MEDIUM, TEST SYSTEM AND ELECTRONIC DEVICE

(75) Inventor: TAKAHIRO YAMAGUCHI, Mivagi (JP)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ADVANTEST CORPORATION, TOKYO (JP)

(21) Appl. No.: 12/414,680

(22) Filed: Mar. 31, 2009

Related U.S. Application Data
(63) Continuation-in-part of application No. 12/257,395, filed on Oct. 24, 2008.

(51) Int. Cl. G06F 11/07; G06F 17/10

(52) U.S. Cl. 714/26; 703/2; 714/E11.024

(57) ABSTRACT

There is provided a deterministic component model identifying apparatus for determining a model of a deterministic component contained in a probability density function supplied thereto. The deterministic component model identifying apparatus includes a spectrum calculating section that calculates a spectrum of the probability density function on an axis of a predetermined variable, a null value detecting section that detects a null value on the axis of the predetermined variable in the calculated spectrum, a theoretical value calculating section that calculates a theoretical value of a spectrum of the deterministic component in association with each of a plurality of predetermined deterministic component models, based on the null value detected by the null value detecting section, and a model determining section that determines the model of the deterministic component contained in the probability density function based on a spectrum difference representing a difference between the spectrum calculated by the spectrum calculating section and the theoretical value of the spectrum of the deterministic component calculated in association with each of the plurality of predetermined deterministic component models.

### CROSS REFERENCE TO RELATED APPLICATION

This is a continuation in-part application of Ser. No. 12/257,395 filed on Oct. 24, 2008, the contents of which are incorporated herein by reference.

### BACKGROUND

1. Technical Field

The present invention relates to a deterministic component model identifying apparatus, a identifying method, a program, a recording medium, a test system, and an electronic device.

2. Related Art

Conventionally, electronic circuits, communication systems and the like may be evaluated based on measurement of characteristic values of electrical signals and the like. In the field of serial communication, for example, communication systems may be evaluated by measuring jitter contained in transmission or reception signals.

A characteristic value such as jitter is divided into deterministic and random components. The deterministic components are deterministically generated according to signal patterns and characteristics of transmission lines and the like, and the random components are randomly generated. To achieve relatively detailed evaluation, the deterministic and random components are preferably separated from each other.

In order to measure deterministic components as well as random components, a histogram (also referred to as a probability density function) is constructed by measuring characteristic values. Conventionally, random components are separated from the resultant histogram in such a manner that the left and right tails of the histogram are approximated by a random distribution (a Gaussian distribution). Furthermore, the deterministic components are separated from the resultant histogram in such a manner that a spacing between two random distributions generated by the approximation is calculated as a peak-to-peak value of the deterministic component.

Here, the conventional separating method assumes that deterministic components contained in a histogram follows a dual-Dirac model. It should be noted, however, that there are other deterministic component models such as a sinusoidal distribution and a uniform distribution. Therefore, the conventional separating method has difficulties in accurately separating jitter into deterministic and random components when a histogram contains other deterministic component models than the dual-Dirac model. For example, as shown in FIG. 2, when a histogram contains deterministic components having a sinusoidal distribution, the conventional separating method yields a peak-to-peak value DJ(δ-δ) for the deterministic components, which is smaller than a true value DJₚ₋ₚ.

U.S. Patent Application Publication No. 2008/0098055 discloses a method to separate, from a probability density function of total jitter, random jitter and a deterministic jitter model with the use of the deterministic jitter model supplied in advance. This method disadvantageously requires the deterministic jitter model contained in the probability density function of total jitter to be known in advance. Therefore, it is necessary to develop the method for identifying the deterministic jitter model in a probability density function.

### SUMMARY

Therefore, it is an object of an aspect of the innovations herein to provide a deterministic component model identifying apparatus, a identifying method, a program, a recording medium, a test system and an electronic device which are capable of overcoming the above drawbacks accompanying the related art. The above and other objects can be achieved by combinations described in the independent claims. The dependent claims define further advantageous and exemplary combinations of the innovations herein.

According to the first aspect related to the innovations herein, one exemplary deterministic component model identifying apparatus includes a deterministic component model identifying apparatus for determining a model of a deterministic component contained in a probability density function supplied thereto. The deterministic component model identifying apparatus includes a spectrum calculating section that calculates a spectrum of the probability density function on an axis of a predetermined variable, a null value detecting section that detects a null value on the axis of the predetermined variable in the calculated spectrum, a theoretical value calculating section that calculates a theoretical value of a spectrum of the deterministic component in association with each of a plurality of predetermined deterministic component models, based on the null value detected by the null value detecting section, and a model determining section that determines the model of the deterministic component contained in the probability density function, based on a spectrum difference representing a difference between the spectrum calculated by the spectrum calculating section and the theoretical value of the spectrum of the deterministic component calculated in association with each of the plurality of predetermined deterministic component models.

The model determining section may determine, as the model of the deterministic component contained in the probability density function, a deterministic component model for which the spectrum difference obtained by subtracting (i) the spectrum calculated by the spectrum calculating section from (ii) the theoretical value of the spectrum of the deterministic component calculated in association with each of the plurality of predetermined deterministic component models takes a positive value smaller than a predetermined value.

The model determining section may determine, as the model of the deterministic component contained in the probability density function, a deterministic component model for which the spectrum difference takes a smallest positive value. When the spectrum calculated by the spectrum calculating section does not exist within a predetermined range, the model determining section may determine that the probability density function only contains a random component.

The null value detecting section may detect a first null value of the spectrum. The model determining section may include a spectrum difference calculating section that calculates, in association with each of the plurality of predetermined deterministic component models, the spectrum difference.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 illustrates an exemplary functional configuration of a deterministic component model identifying apparatus 100 relating to an embodiment of the present invention.

FIG. 2 illustrates an example of a probability density function supplied to the deterministic component model identifying apparatus 100.

FIG. 3A shows a deterministic component having a uniform distribution.

FIG. 3B shows a deterministic component having a trapezoid distribution.

FIG. 4A shows a deterministic component having a dual-Dirac distribution.

FIG. 4B shows a deterministic component having a single-Dirac distribution.

FIG. 5A is used to explain a deterministic component having a sinusoidal distribution.

FIG. 5B is used to explain a deterministic component having a uniform distribution.

FIG. 6A shows, as an example, a probability density function h(t) supplied to the deterministic component model identifying apparatus 100 and a spectrum H(f) of the probability density function h(t).

FIG. 6B shows, as an example, a deterministic component d(t) having a uniform distribution and a spectrum D(f) of the distribution.

FIG. 6C shows a random component g(t) contained in the probability density function h(t) and a comparison between the spectrum H(f) of the probability density function and the spectrum D(f) of the deterministic component.

FIG. 7 is a table showing, in association with each deterministic component model, a model formula in the time domain, a model formula in the frequency domain, and a relation between a first null frequency f_{zero} and a peak-to-peak value DJₚ₋ₚ.

FIG. 8 illustrates an exemplary configuration of a model determining section 40.

FIG. 9 illustrates, as an example, the spectrum H(f) of the probability density function PDF and a theoretical value of a spectrum of each deterministic component model.

FIG. 10 illustrates, as an example, a theoretical value of a spectrum of each deterministic component model and a measured spectrum of the probability density function PDF.

FIG. 11 is a flow chart briefly illustrating the operations performed by the deterministic component model identifying apparatus 100.

FIG. 12 illustrates an exemplary configuration of a test system 300 relating to an embodiment of the present invention.

FIG. 13 illustrates an exemplary configuration of an electronic device 400 relating to an embodiment of the present invention.

FIG. 14 illustrates an exemplary hardware configuration of a computer 1900 relating to an embodiment of the present invention.

### DESCRIPTION OF EXEMPLARY EMBODIMENTS

Some aspects of the invention will now be described based on the embodiments, which do not intend to limit the scope of the present invention, but exemplify the invention. All of the features and the combinations thereof described in the embodiment are not necessarily essential to the invention.

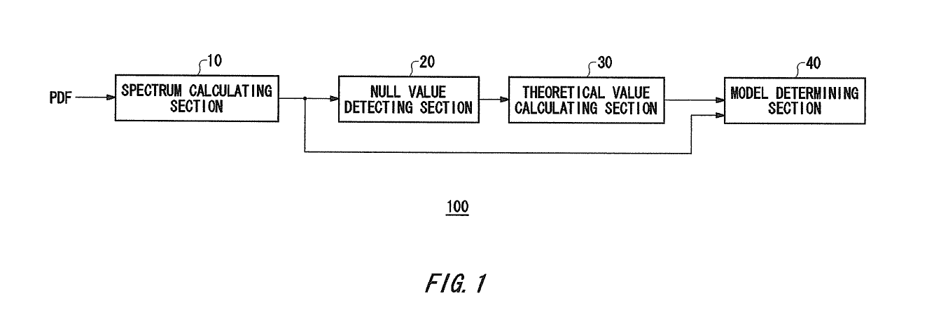

FIG. 1 illustrates an exemplary functional configuration of a deterministic component model identifying apparatus 100 relating to an embodiment of the present invention. The deterministic component model identifying apparatus 100 relating to the present example determines the model of the deterministic component contained in a supplied probability density function PDF. The deterministic component model identifying apparatus 100 relating to the present example includes a spectrum calculating section 10, a null value detecting section 20, a theoretical value calculating section 30, and a model determining section 40.

The spectrum calculating section 10 calculates the spectrum of the supplied probability density function PDF on an axis of a predetermined variable. For example, the spectrum calculating section 10 may receive a probability density function PDF on the time axis and calculate a spectrum on the frequency axis. The spectrum calculating section 10 may calculate a spectrum by performing Fourier transform on a real-number probability density function PDF. Alternatively, the spectrum calculating section 10 may calculate a spectrum by performing inverse Fourier transform on a real-number probability density function PDF. The following describes the functions of the deterministic component model identifying apparatus 100 in an exemplary case where the spectrum calculating section 10 calculates a spectrum on the frequency axis.

The null value detecting section 20 detects a null value on the predetermined variable axis for the spectrum calculated by the spectrum calculating section 10. According to the present example, the null value detecting section 20 detects a null frequency of the spectrum. Here, the null frequency of the spectrum represents a frequency at which the power of the spectrum is substantially zero (or a frequency at which the spectrum indicates a minimal value).

The theoretical value calculating section 30 uses the null value detected by the null value detecting section 20 to calculate a theoretical value of a spectrum of the deterministic component in association with each of a predetermined set of deterministic component models. According to the present example, the theoretical value calculating section 30 uses a first null frequency detected by the null value detecting section 20 to calculate each theoretical value. Here, multiple deterministic component models may correspond to, for example, a sinusoidal distribution, a uniform distribution, a trapezoid distribution, and a dual-Dirac distribution. As will be explained later, a theoretical value of a deterministic component can be defined by a deterministic component model and a peak-to-peak value DJₚ₋ₚ.

The model determining section 40 determines the model of the deterministic component contained in the probability density function PDF, based on the spectrum calculated by the spectrum calculating section 10 and the theoretical value of the spectrum, calculated by the theoretical value calculating section 30, for each deterministic component model. The model determining section 40 determines the model of the deterministic component contained in the probability density function PDF based on a spectrum difference representing a difference between the spectrum calculated by the spectrum calculating section 10 and the theoretical spectrum for each deterministic component model.

Here, the probability density function PDF is given as a result of combining together (or convolving) deterministic and random components. It is assumed here that the probability density function PDF contains a single dominant deterministic component and a relatively small random component. For example, a case may be assumed where the value obtained by dividing a peak-to-peak value of the deterministic component by the standard deviation of the random component is equal to or larger than a predetermined value.

Since, if the random component is small, the spectrum of the random component (also referred to as a characteristic function) takes a substantially constant value, the spectrum of the probability density function PDF substantially matches the spectrum of the deterministic component. For this reason, when the probability density function PDF contains a single dominant deterministic component and a relatively small random component, it is possible to identify the model of the deterministic component by finding a deterministic component model for which a value obtained by subtracting the spectrum of the probability density function PDF from the spectrum of the deterministic component model is the smallest (and/or smaller than a predetermined value).

When the value obtained by subtracting the spectrum of the probability density function PDF from the spectrum of the deterministic component is a negative value, the standard deviation of the random component is a pure imaginary number, which is physically insignificant or meaningless. Therefore, the model determining section 40 preferably selects a deterministic component model for which the value obtained by subtracting the spectrum of the probability density function PDF from the spectrum of the deterministic component model is the smallest positive value (and/or a positive value smaller than a predetermined value).

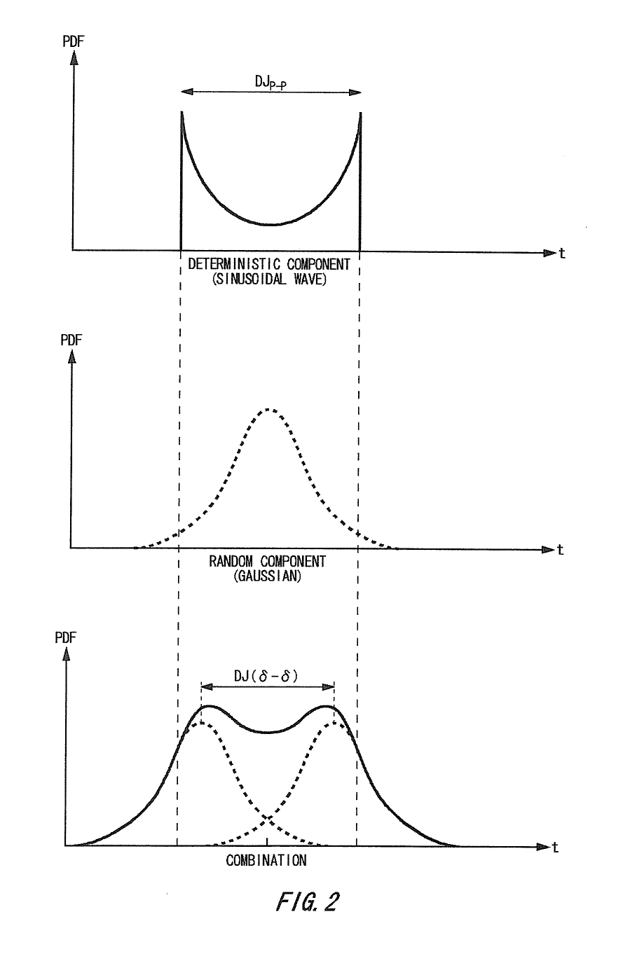

FIG. 2 illustrates an example of the probability density function supplied to the deterministic component model identifying apparatus 100. The probability density function may be a function representing a distribution of measured values, which is obtained by measuring a predetermined characteristic of an electrical circuit or the like multiple times. The predetermined characteristic may be a jitter amount, an amplitude value, a DC value or the like of the signal output from an electrical circuit, an optical circuit or the like.

For example, the jitter amount may indicate phase noise of the signal. More specifically, the jitter amount may denote the difference between signal edge timings and ideal edge timings. In this case, the probability density function may represent a distribution of measured value (occurrence probability) obtained by measuring the jitter amount of each signal edge. The amplitude value may denote the amplitude of the voltage, current, light intensity or the like of the signal. The DC value may denote the DC level of the voltage, current, light intensity or the like of the signal.

Generally speaking, a probability density function of any of the above-mentioned characteristics contains deterministic and random components. For example, a probability density function of jitter amounts contains a deterministic jitter component that is deterministically generated by signal patterns, characteristics of transmission lines or the like and a random jitter component that is randomly generated by thermal noise or the like.

Here, the random component contained in the probability density function is given by a Gaussian distribution as shown in FIG. 2. It should be noted that the spectrum of the random component is also represented by a Gaussian distribution. On the other hand, the deterministic component is given by any one of a plurality of different models depending on its causes or the like. In FIG. 2, for example, the model of the deterministic component is a sinusoidal distribution. Alternatively, however, the model of the deterministic component may be a uniform distribution, a trapezoid distribution, a dual-Dirac distribution, a single-Dirac distribution or the like.

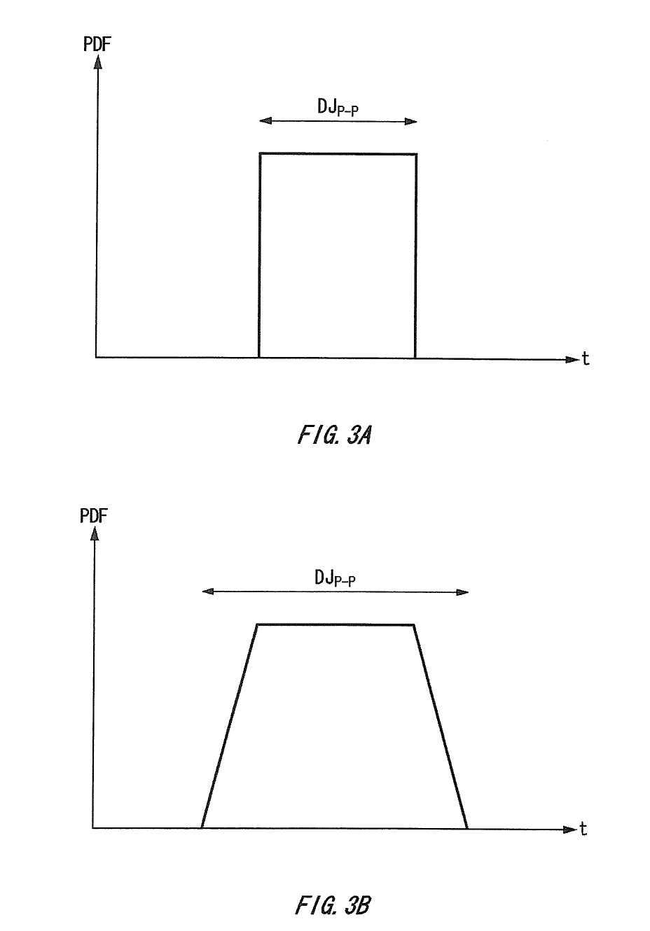

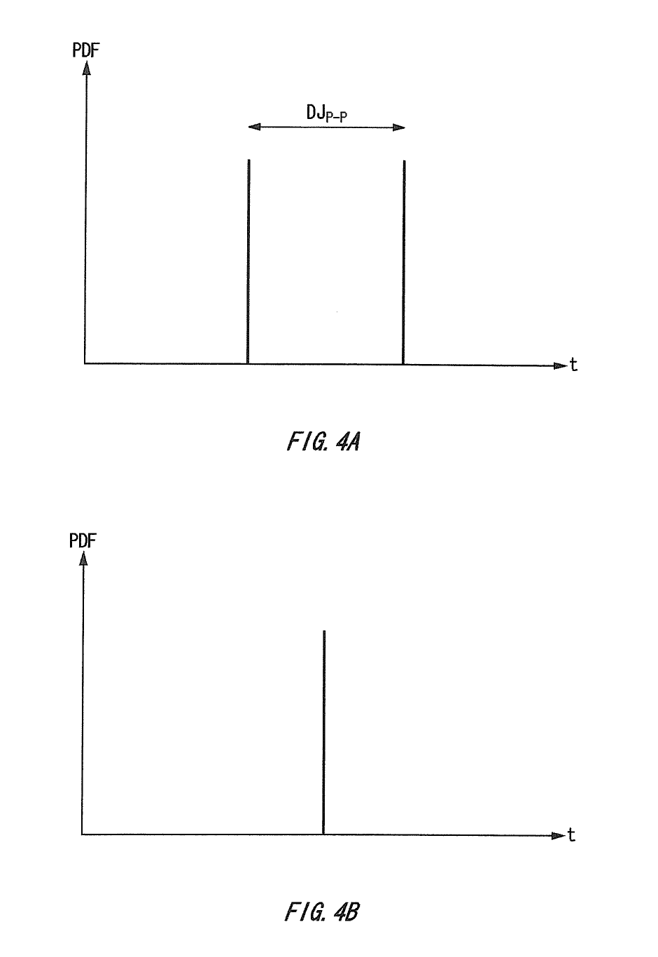

FIGS. 3A, 3B, 4A and 4B show probability density functions representing deterministic components in multiple different models. FIG. 3A shows a deterministic component having a uniform distribution. FIG. 3B shows a deterministic component having a trapezoid distribution. FIG. 4A shows a deterministic component having a dual-Dirac distribution. FIG. 4B shows a deterministic component having a single-Dirac distribution.

As seen from FIGS. 2 to 4B, a distribution of a deterministic component can be uniquely defined if its peak-to-peak value DJₚ₋ₚ is determined regardless of which model the deterministic component has. To uniquely define a trapezoid distribution of a deterministic component, however, it is preferable to further know the ratio between the upper and lower sides. A deterministic component having a single-Dirac distribution is represented as having a peak-to-peak value of substantially zero. The deterministic component model identifying apparatus 100 relating to the present example calculates a peak-to-peak value DJₚ₋ₚ of a deterministic component based on a first null frequency in a spectrum of a probability density function.

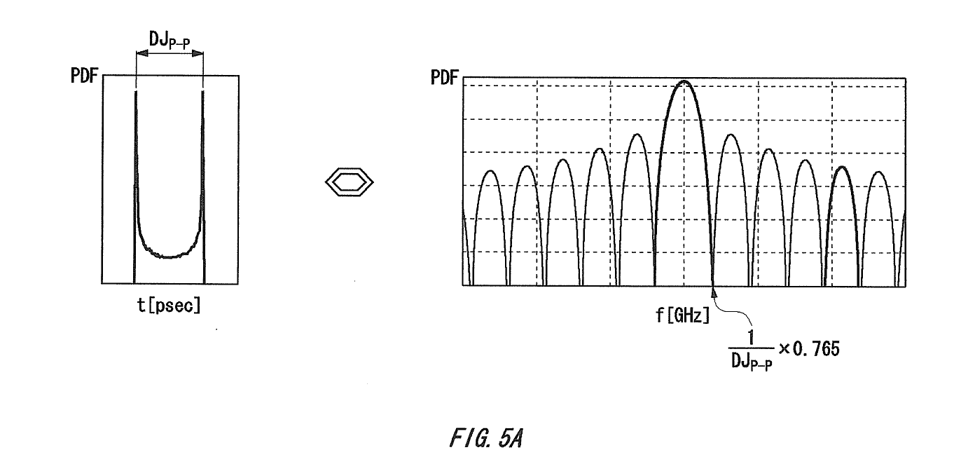

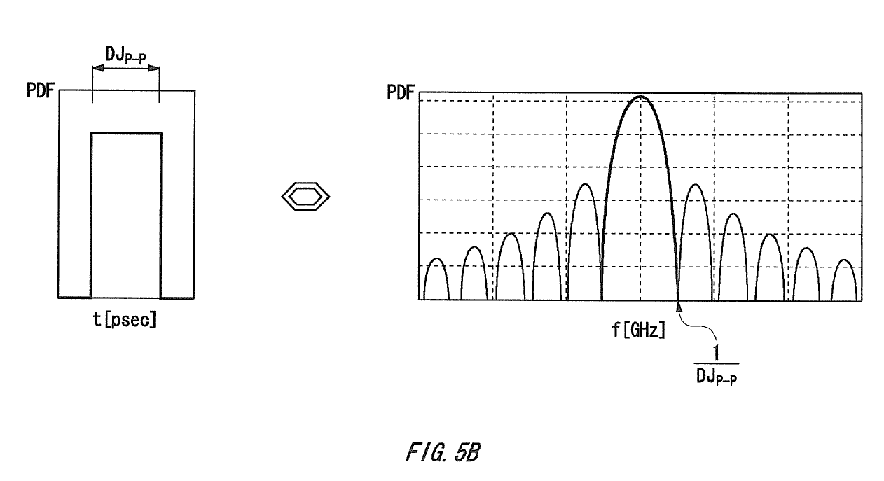

FIGS. 5A and 5B each show a probability density function of a deterministic component of a predetermined model and a spectrum of the probability density function. FIG. 5A is used to explain a deterministic component having a sinusoidal distribution. FIG. 5B is used to explain a deterministic component having a uniform distribution. In FIGS. 5A and 5B, the left waveform shows a probability density function in the time domain, the right waveform shows a spectrum of the probability density function, and DJₚ₋ₚ denotes the peak-to-peak value of the deterministic component in the time domain.

As seen from FIG. 5A, the first null frequency of the spectrum obtained by performing Fourier transform on the probability density function of a deterministic component having a sinusoidal distribution is given by 0.765/DJₚ₋ₚ. Therefore, the peak-to-peak value DJₚ₋ₚ of the deterministic component can be calculated by multiplying the inverse of the first null frequency by the coefficient of 0.765.

As seen from FIG. 5B, the first null frequency of the spectrum obtained by performing Fourier transform on the probability density function of a deterministic component having a uniform distribution is given by 1/DJₚ₋ₚ. Therefore, the peak-to-peak value DJₚ₋ₚ of the deterministic component can be calculated by obtaining the inverse of the first null frequency.

When the deterministic component has a different model of distribution such as a trapezoid distribution or dual-Dirac distribution, the peak-to-peak value can be similarly calculated based on the first null frequency. It should be noted that, however, the relation between the first null frequency and the peak-to-peak value DJₚ₋ₚ varies depending on the model of the deterministic component as seen from FIGS. 5A and 5B. Therefore, it is essential to determine the model of the deterministic component in order to accurately calculate the deterministic component.

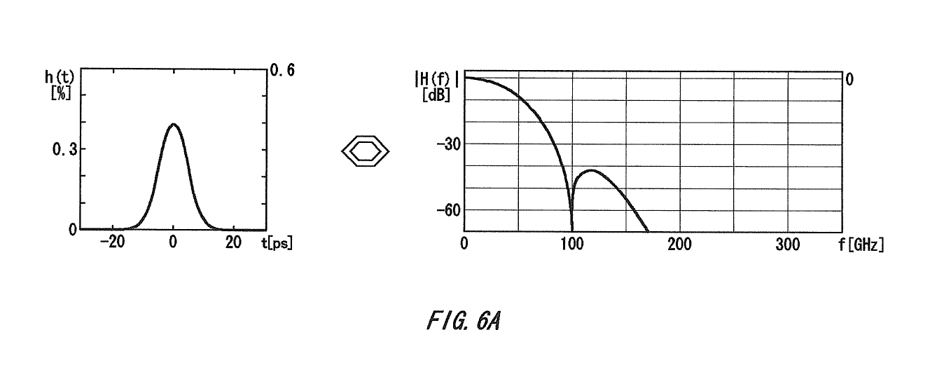

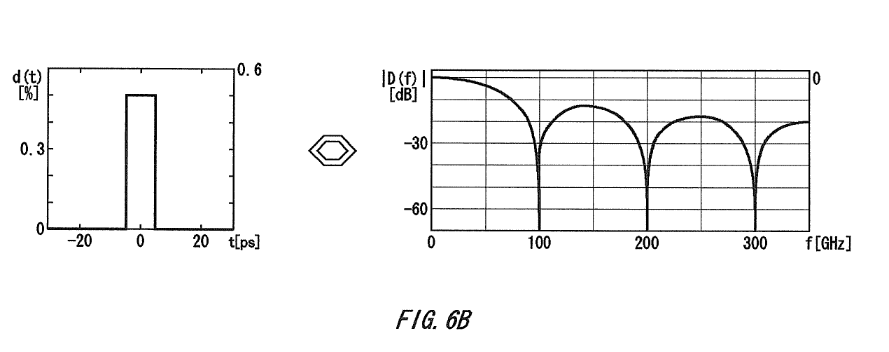

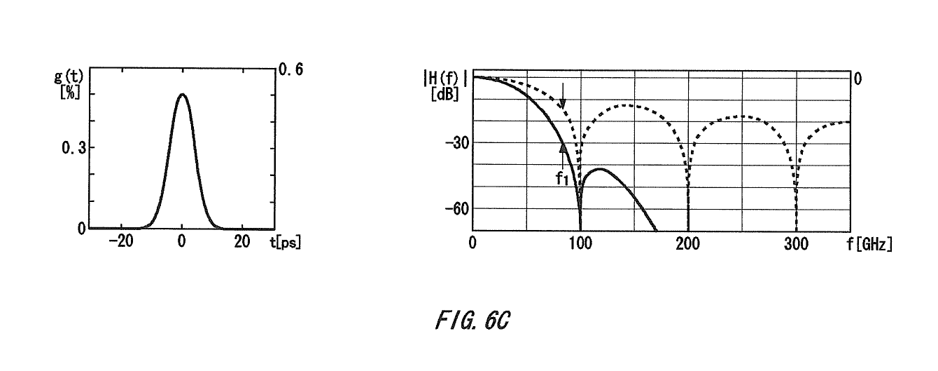

FIG. 6A shows, as an example, a probability density function h(t) supplied to the deterministic component model identifying apparatus 100 and a spectrum H(f) of the probability density function h(t). FIG. 6B shows, as an example, a deterministic component d(t) having a uniform distribution and a spectrum D(f) of the distribution. FIG. 6C shows a random component g(t) contained in the probability density function h(t) and a comparison between the spectrum H(f) of the probability density function and the spectrum D(f) of the deterministic component.

The spectrum calculating section 10 receives the probability density function h(t) shown in FIG. 6A, and calculates the power spectrum |H(f)| of the received probability density function. The null value detecting section 20 detects a first null frequency of the spectrum |H(f)| shown in FIG. 6A. According to the present example, the spectrum calculating section 10 detects, as the first null frequency, 100 GHz at which the spectrum |H(f)| becomes substantially zero.

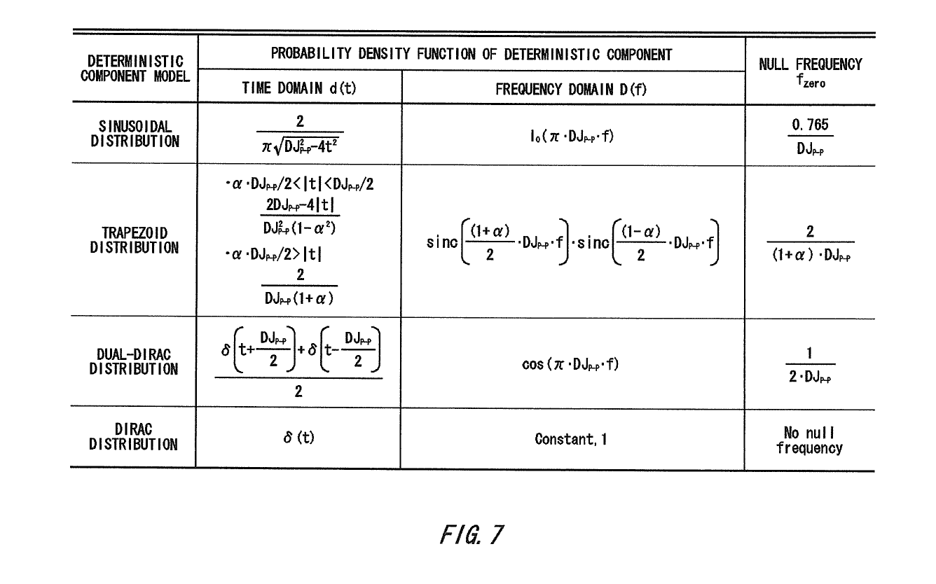

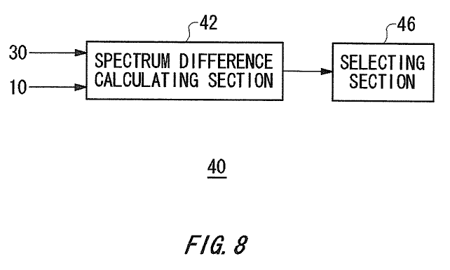

The theoretical value calculating section 30 calculates a theoretical value of a spectrum of a deterministic component of each predetermined model, by using the first null frequency of the spectrum |H(f)|. For example, the spectrum shown in FIG. 6B is calculated in association with a deterministic component having a uniform distribution. It should be noted that the first null frequency of the probability density function h(t) is substantially the same as the first null frequency of the spectrum of the deterministic component contained in the probability density function h(t). How to calculate the theoretical value of the spectrum of the deterministic component by referring to the first null frequency will be described later with reference to FIG. 7.

The model determining section 40 determines the model of the deterministic component based on the spectrum |H(f)| and the spectrum |D(f)|. The model determining section 40 may calculate a spectrum difference representing a difference between the spectrum |H(f)| and the spectrum |D(f)|.

FIG. 7 is a table showing, in association with each deterministic component model, a model formula in the time domain, a model formula in the frequency domain, and a relation between a first null frequency f_{zero} and a peak-to-peak value DJₚ₋ₚ. In FIG. 7, I₀ denotes a zero-th order Bessel function of the first kind.

In FIG. 7, α denotes the ratio of the upper side to the lower side in relation to a trapezoid distribution. In other words, a trapezoid distribution is equivalent to a uniform distribution when α=1 and equivalent to a triangular distribution when α=0. It should be noted that the deterministic component model identifying apparatus 100 can deal with any other deterministic component models than the above-mentioned models. The deterministic component model identifying apparatus 100 may be configured for all of the deterministic component models for which the peak-to-peak value can be calculated from the first null frequency of the spectrum.

As presented in FIG. 7, the theoretical value of the spectrum of the deterministic component can be defined by the model of the deterministic component and the first null frequency. The theoretical value calculating section 30 may be provided with a table, such as shown in FIG. 7, indicating a model formula in the frequency domain and a relation between the first null frequency f_{zero} and the peak-to-peak value DJₚ₋ₚ in association with each deterministic component model. The theoretical value calculating section 30 may calculate a theoretical value for each deterministic component model with reference to this table.

FIG. 8 illustrates an exemplary configuration of the model determining section 40. According to the present example, the model determining section 40 includes a spectrum difference calculating section 42 and a selecting section 46. The spectrum difference calculating section 42 calculates, in association with each deterministic component model, a spectrum difference by subtracting the spectrum H(f) calculated by the spectrum calculating section 10 from the theoretical value of the spectrum D(f) of the deterministic component.

The spectrum H(f) of the probability density function PDF is represented by the following equation by using the spectrum G(f) of the random component and the spectrum D(f) of the deterministic component.

H(ƒ)=D(ƒ)·R(ƒ) Equation 1

Here, the random component exhibits a Gaussian distribution, and Equation 1 can be thus changed into the following equation.

H(ƒ)=D(ƒ·e^{-ƒ}^{²}^{/2σ}^{_{ƒ}}^{²} Equation 2

As mentioned above, when the standard deviation of the random component is sufficiently small, the spectrum R(f) of the random component can be considered substantially constant. Accordingly, Equation 2 can be changed as follows.

H(ƒ)≈D(ƒ) Equation 3

Therefore, the model of the deterministic component can be identified by finding a characteristic function D (f) for which the spectrum difference D(f)−H(f) takes the smallest positive value.

The spectrum difference calculating section 42 calculates the spectrum difference D(f)−H(f) in association with each of a plurality of predetermined deterministic component models. The spectrum difference calculating section 42 may first transform the theoretical value D(f) of the spectrum of a deterministic component of each model and the spectrum H(f) calculated by the spectrum calculating section 10 into logarithms with a base of e or 10, for example, and then calculate the difference D(f)−H(f) between the resultant logarithms. The base of the logarithms may be set at any irrational number.

The selecting section 46 then selects a deterministic component model for which the spectrum difference takes the smallest positive value. In this manner, for a probability density function PDF containing one dominant deterministic component and a relatively small random component, the model of the deterministic component can be identified.

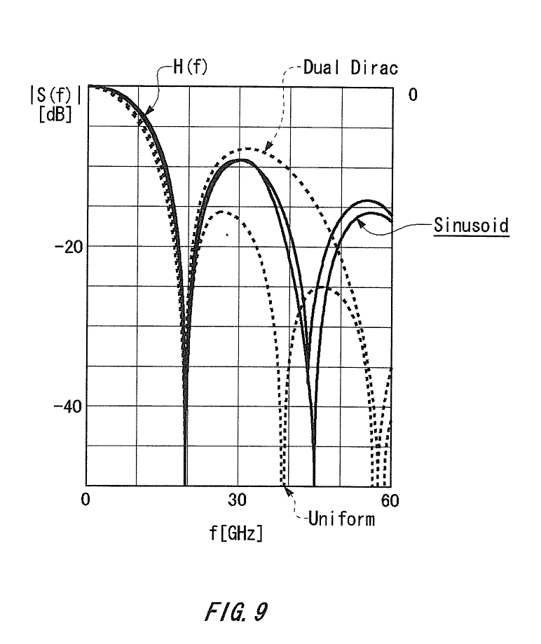

FIG. 9 illustrates, as an example, the spectrum H(f) of the probability density function PDF and a theoretical value of a spectrum of a deterministic component of each model. The deterministic component models shown in FIG. 9 include a sinusoidal distribution, a uniform distribution, and a dual-Dirac distribution. It should be noted that, in the present example, the probability density function PDF contains a deterministic component having a sinusoidal distribution. As shown in FIG. 9, the first and second null frequencies of a theoretical spectrum obtained assuming that the contained deterministic component has a sinusoidal distribution are substantially the same as the null frequencies of the probability density function PDF containing a sinusoidal distribution.

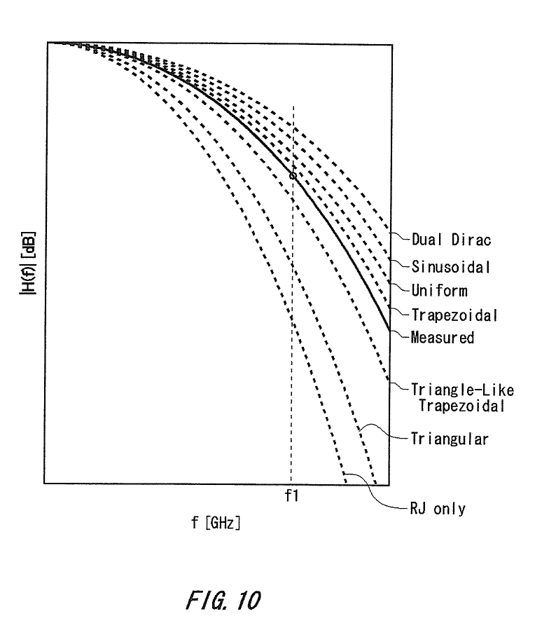

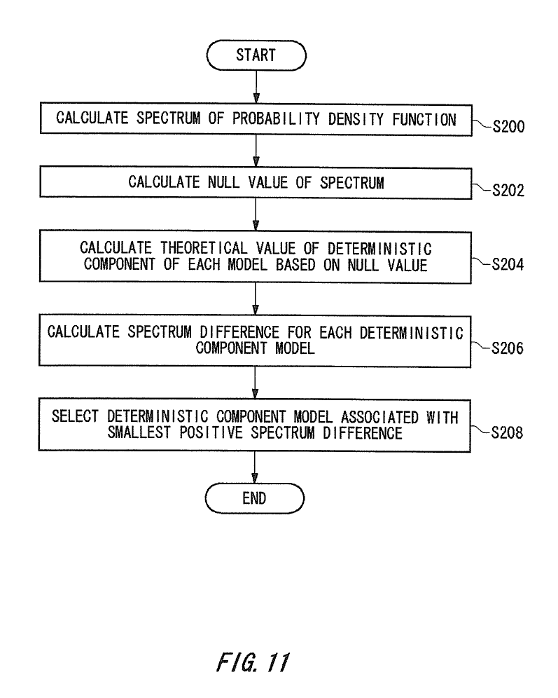

FIG. 10 illustrates, as an example, a theoretical value of a spectrum of each deterministic component model and a measured spectrum of the probability density function PDF. The measured spectrum of the probability density function PDF corresponds to the above-mentioned spectrum output from the spectrum calculating section 10.

Note that FIG. 10 shows part of the main lobes of the respective spectra in enlargement. In FIG. 10, the dotted lines represent spectra for the dual-Dirac, sinusoidal, uniform distribution, trapezoidal distribution, and triangle-like trapezoidal distribution, and triangular distribution deterministic component models and the solid line represents the measured spectrum of the probability density function PDF.

The model determining section 40 selects among the plurality of deterministic component models a deterministic component model such that the value obtained by subtracting the measured spectrum from the spectrum of the selected deterministic component model takes the smallest positive value. Specifically in the example shown in FIG. 10, the model determining section 40 selects a deterministic component model associated with a spectrum that is larger than the measured spectrum and closest to the measured spectrum. In the example shown in FIG. 10, the model determining section 40 selects the trapezoidal distribution.

It should be noted that the model determining section 40 may compare the respective spectra at a predetermined frequency f1. For example, the model determining section 40 may compare the values of the respective spectra at a frequency bin that is closest to the DC component among the frequency bins of the spectra. In this case, the spectrum difference calculating section 42 calculates the spectrum difference at the frequency f1.

When the spectrum calculated by the spectrum calculating section 10 does not exist within a predetermined range, the model determining section 40 may determine that the probability density function PDF only contains a random component. For example, in a case where the spectrum calculated by the spectrum calculating section 10 is no more than a predetermined reference spectrum, the model determining section 40 may determine that the probability density function PDF only contains a random component.

For example, as the reference spectrum used to judge whether the probability density function PDF only contains a random component, the model determining section 40 may be provided with a reference spectrum (RJ_only), which is smaller than the spectrum for the triangular distribution model, as shown in FIG. 10. Alternatively, the model determining section 40 may be provided with a value of the reference spectrum at the above-mentioned frequency f1.

The reference spectrum or the value of the reference spectrum at the frequency f1 may be set in advance in the spectrum calculating section 10. In this case, it may be the spectrum calculating section 10 which determines whether the probability density function PDF contains deterministic and random components or only a random component.

FIG. 11 is a flow chart briefly illustrating the operations performed by the deterministic component model identifying apparatus 100. As discussed above, the spectrum calculating section 10 calculates a spectrum of a supplied probability density function (step S200). Subsequently, the null value detecting section 20 detects a first null value in the spectrum calculated by the spectrum calculating section 10 (step S202).

After this, the theoretical value calculating section 30 calculates a theoretical value of a deterministic component spectrum based on the first null value, in association with each predetermined deterministic component model (step S204). Following this, the spectrum difference calculating section 42 calculates a spectrum difference for each deterministic component model (step S206).

Subsequently, the selecting section 46 selects a deterministic component model for which the smallest positive spectrum difference is calculated in the step S206. In the above-described manner, the deterministic component model identifying apparatus 100 can estimate the model of the deterministic component contained in the probability density function.

In a case where the random component contained in the probability density function PDF is not sufficiently small, the above-described procedure may select an incorrect deterministic component model. Therefore, the model determining section 40 may use the above-described procedure to determine the model of the deterministic component when the standard deviation of the random component contained in the probability density function PDF is smaller than a predetermined value.

In association with each deterministic component model, the ratio between the peak-to-peak value of the deterministic component and the magnitude of the random component which enables the deterministic component model identifying apparatus 100 to accurately determine the model of the deterministic component is calculated in advance. For example, simulation can prove that, for a deterministic component having a dual-Dirac distribution, the deterministic component model identifying apparatus 100 can correctly determine the model of the deterministic component with the probability of substantially 100% if the ratio DJₚ₋ₚ/σ between the peak-to-peak value of the deterministic component and the standard deviation of the random component is equal to or more than 2.50.

The model determining section 40 may calculate the peak-to-peak value of the deterministic component and the standard deviation of the random component based on the model of the deterministic component selected in accordance with the procedure described with reference to FIG. 11. When the ratio between the peak-to-peak value of the deterministic component and the standard deviation of the random component exceeds a predetermined threshold value (for example, a threshold value confirmed in advance by simulation) for each deterministic component model, the model determining section 40 may determine that the selected deterministic component model is correct. When the ratio between the peak-to-peak value of the deterministic component and the standard deviation of the random component is smaller than a predetermined threshold value for each deterministic component model, the model determining section 40 may notify a user or the like of the possibility of incorrect deterministic component model selection.

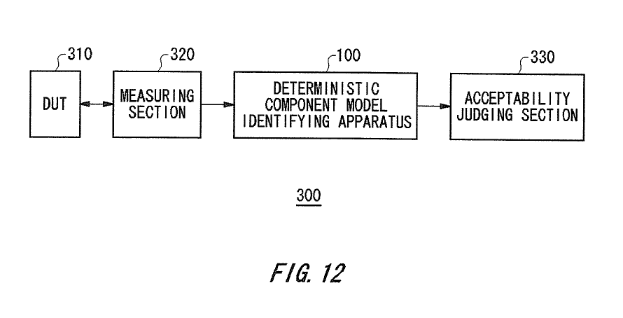

FIG. 12 illustrates an exemplary configuration of a test system 300 relating to an embodiment of the present invention. The test system 300 is designed to test a device under test such as a semiconductor circuit or communication device. The test system 300 includes a measuring section 320, a deterministic component model identifying apparatus 100, and an acceptability judging section 330.

The measuring section 320 measures a predetermined characteristic of the device under test 310 multiple times and generates a probability density function of the measured values of the predetermined characteristic. For example, the measuring section 320 may measure the jitter, voltage, current or the like of the signal output from the device under test 310.

The deterministic component model identifying apparatus 100 determines the model of the deterministic component contained in the probability density function representing the characteristic values measured by the measuring section 320. The deterministic component model identifying apparatus 100 may calculate at least one of the deterministic and random components contained in the probability density function.

For example, the deterministic component model identifying apparatus 100 may calculate the probability density function or peak-to-peak value of the deterministic component as shown in FIG. 7, by referring to the first null frequency and the model of the deterministic component. Also, the deterministic component model identifying apparatus 100 may calculate the random component contained in the measured probability density function PDF based on the identified deterministic component model.

The acceptability judging section 330 judges whether the device under test 310 is acceptable based on the deterministic or random component calculated by the deterministic component model identifying apparatus 100. For example, the acceptability judging section 330 may judge whether one of the deterministic and random components calculated by the deterministic component model identifying apparatus 100 satisfies a predetermined specification. With the above-described configuration, the test system 300 can accurately judge the acceptability of the device under test 310.

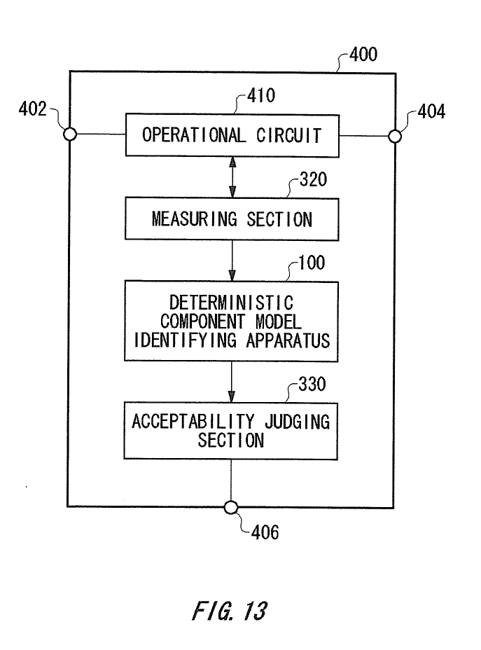

FIG. 13 illustrates an exemplary configuration of an electronic device 400 relating to an embodiment of the present invention. According to the present example, the electronic device 400 operates in accordance with a signal supplied through an input pin 402, and outputs a generated predetermined signal thorough an output pin 404. The electronic device 400 includes an operational circuit 410, a measuring section 320, a deterministic component model identifying apparatus 100, and an acceptability judging section 330.

The operational circuit 410 operates in accordance with a signal supplied thereto. The operational circuit 410 may generate a predetermined signal as a result of the operation.

The measuring section 320, the deterministic component model identifying apparatus 100, and the acceptability judging section 330 together function as a BIST circuit that is designed to test whether the operational circuit 410 correctly operates.

The measuring section 320 measures a predetermined characteristic of the predetermined signal generated by the operational circuit 410, to generate a probability density function. The deterministic component model identifying apparatus 100 determines the model of the deterministic component contained in the probability density function generated by the measuring section 320, and then calculates the deterministic and random components.

The acceptability judging section 330 judges whether the operational circuit 410 is acceptable based on the deterministic and random components calculated by the deterministic component model identifying apparatus 100. The measuring section 320, the deterministic component model identifying apparatus 100, and the acceptability judging section 330 may be the same as the measuring section 320, the deterministic component model identifying apparatus 100, and the acceptability judging section 330 described with reference FIG. 12.

The acceptability judging section 330 may output the result of the judgment as to whether the operational circuit 410 is acceptable to outside through a test pin 406. With the above-described configuration, the electronic device 400 can accurately self-diagnose the operational circuit 410.

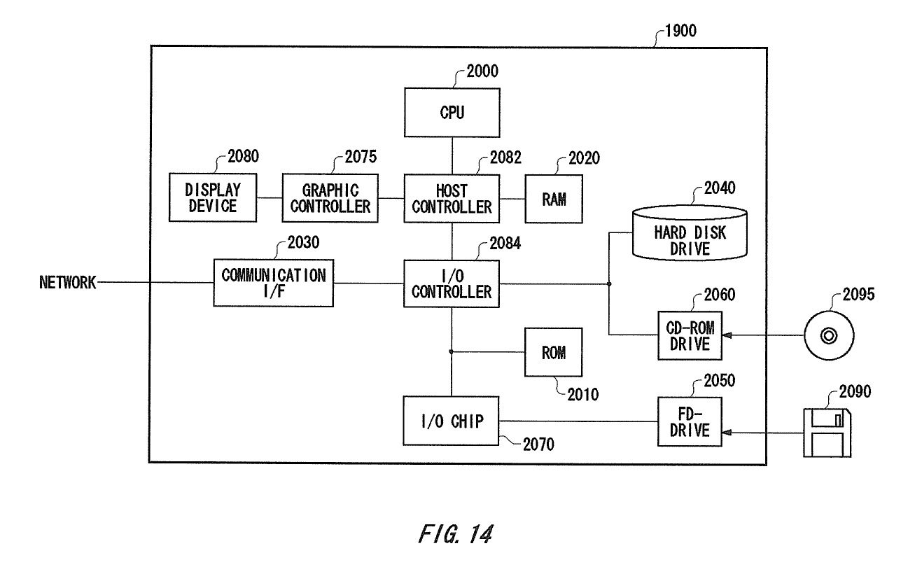

FIG. 14 illustrates an exemplary hardware configuration of a computer 1900 relating to an embodiment of the present invention. The computer 1900 functions as the deterministic component model identifying apparatus 100 described with reference to FIGS. 1 to 11 in accordance with programs supplied thereto. The programs may cause the computer 1900 to function as the respective constituents of the deterministic component model identifying apparatus 100 described with reference to FIGS. 1 to 11.

The computer 1900 relating to the present embodiment is constituted by a CPU peripheral section, an input/output (I/O) section and a legacy I/O section. The CPU peripheral section includes a CPU 2000, a RAM 2020, a graphic controller 2075 and a display device 2080 which are connected to each other by means of a host controller 2082. The I/O section includes a communication interface 2030, a hard disk drive 2040, and a CD-ROM drive 2060 which are connected to the host controller 2082 by means of an I/O controller 2084. The legacy I/O section includes a ROM 2010, a flexible disk drive 2050, and an I/O chip 2070 which are connected to the I/O controller 2084.

The host controller 2082 connects the RAM 2020 with the CPU 2000 and graphic controller 2075 which access the RAM 2020 at a high transfer rate. The CPU 2000 operates in accordance with programs stored on the ROM 2010 and RAM 2020, to control the constituents. The graphic controller 2075 obtains image data which is generated by the CPU 2000 or the like on a frame buffer provided within the RAM 2020, and causes the display device 2080 to display the obtained image data. Alternatively, the graphic controller 2075 may include therein a frame buffer for storing thereon the image data generated by the CPU 2000 or the like.

The I/O controller 2084 connects, to the host controller 2082, the hard disk drive 2040, communication interface 2030 and CD-ROM drive 2060 which are I/O devices operating at a relatively high rate. The communication interface 2030 communicates with different apparatuses via the network. The hard disk drive 2040 stores thereon programs and data to be used by the CPU 2000 in the computer 1900. The CD-ROM drive 2060 reads programs or data from a CD-ROM 2095, and supplies the read programs or data to the hard disk drive 2040 via the RAM 2020.

The I/O controller 2084 is also connected to the ROM 2010, flexible disk drive 2050 and I/O chip 2070 which are I/O devices operating at a relatively low rate. The ROM 2010 stores thereon a boot program executed by the computer 1900 at the startup, programs dependent on the hardware of the computer 1900, and the like. The flexible disk drive 2050 reads programs or data from a flexible disk 2090, and supplies the read programs or data to the hard disk drive 2040 via the RAM 2020. The I/O chip 2070 is connected to the flexible disk drive 2050, and used to connect a variety of I/O devices to the computer 1900, via a parallel port, a serial port, a keyboard port, a mouse port or the like.

The programs to be provided to the hard disk drive 2040 via the RAM 2020 are provided by a user in the state of being stored on a recording medium such as the flexible disk 2090, the CD-ROM 2095, and an IC card. The programs are read from the recording medium, and the read programs are installed in the hard disk drive 2040 in the computer 1900 via the RAM 2020, to be executed by the CPU 2000. The programs are installed in the computer 1900 and cause the computer 1900 to function as the deterministic component model identifying apparatus 100 when executed by the CPU 2000 and the like.

The programs mentioned above may be stored on an external recording medium. Such a recording medium is, for example, an optical recording medium such as DVD and CD, a magnet-optical recording medium such as MO, a tape medium, a semiconductor memory such as an IC card and the like, in addition to the flexible disk 2090 and CD-ROM 2095. Alternatively, the recording medium may be a storage device such as a hard disk or RAM which is provided in a server system connected to a dedicated communication network or the Internet, and the programs may be provided to the computer 1900 via the network.

Although some aspects of the present invention have been described by way of exemplary embodiments, it should be understood that those skilled in the art might make many changes and substitutions without departing from the spirit and the scope of the present invention which is defined only by the appended claims.

The claims, specification and drawings describe the processes of an apparatus, a system, a program and a method by using the terms such as operations, procedures, steps and stages. When a reference is made to the execution order of the processes, wording such as “before” or “prior to” is not explicitly used. The processes may be performed in any order unless an output of a particular process is used by the following process. In the claims, specification and drawings, a flow of operations may be explained by using the terms such as “first” and “next” for the sake of convenience. This, however, does not necessarily indicate that the operations should be performed in the explained order.

As is apparent from the above description, an embodiment of the present invention can employ a simple configuration to realize a deterministic component model identifying apparatus that can accurately determine the model of a deterministic component contained in a probability density function.

What is claimed is:

1. A deterministic component model identifying apparatus for determining a model of a deterministic component contained in a probability density function supplied thereto, comprising:
a spectrum calculating section that calculates a spectrum of the probability density function on an axis of a predetermined variable;
a null value detecting section that detects a null value on the axis of the predetermined variable in the calculated spectrum;
a theoretical value calculating section that calculates a theoretical value of a spectrum of the deterministic component in association with each of a plurality of predetermined deterministic component models, based on the null value detected by the null value detecting section; and
a model determining section that determines the model of the deterministic component contained in the probability density function, based on a spectrum difference representing a difference between the spectrum calculated by the spectrum calculating section and the theoretical value of the spectrum of the deterministic component calculated in association with each of the plurality of predetermined deterministic component models.

2. The deterministic component model identifying apparatus as set forth in claim 1, wherein
the model determining section determines, as the model of the deterministic component contained in the probability density function, a deterministic component model for which the spectrum difference obtained by subtracting (i) the spectrum calculated by the spectrum calculating section from (ii) the theoretical value of the spectrum of the deterministic component calculated in association with each of the plurality of predetermined deterministic component models takes a positive value smaller than a predetermined value.

3. The deterministic component model identifying apparatus as set forth in claim 1, wherein
the model determining section determines, as the model of the deterministic component contained in the probability density function, a deterministic component model for which the spectrum difference takes a smallest positive value.

4. The deterministic component model identifying apparatus as set forth in claim 3, wherein
when the spectrum calculated by the spectrum calculating section does not exist within a predetermined range, the model determining section determines that the probability density function only contains a random component.

5. The deterministic component model identifying apparatus as set forth in claim 3, wherein
the null value detecting section detects a first null value of the spectrum.

6. The deterministic component model identifying apparatus as set forth in claim 3, wherein
the model determining section includes
a spectrum difference calculating section that calculates, in association with each of the plurality of predetermined deterministic component models, the spectrum difference.

7. A deterministic component model identifying method for determining a model of a deterministic component contained in a supplied probability density function, comprising:
calculating a spectrum of the probability density function on an axis of a predetermined variable;
detecting a null value on the axis of the predetermined variable in the calculated spectrum;
calculating a theoretical value of a spectrum of the deterministic component in association with each of a plurality of predetermined deterministic component models, based on the detected null value; and
determining the model of the deterministic component contained in the probability density function based on a spectrum difference representing a difference between the calculated spectrum and the theoretical value of the spectrum of the deterministic component calculated in association with each of the plurality of predetermined deterministic component models.

8. A program for causing a computer to function as the deterministic component model identifying apparatus as set forth in claim 1.

9. A recoding medium recording therein the program as set forth in claim 8.

10. A test system for testing a device under test, comprising:
a measuring section that measures a predetermined characteristic of the device under test multiple times;
the deterministic component model identifying apparatus as set forth in claim 1 that determines a model of a deterministic component contained in a probability density function of the characteristic measured by the measuring section and calculates the deterministic component; and
an acceptability judging section that judges whether the device under test is acceptable, based on the deterministic component calculated by the deterministic component model identifying apparatus.

11. An electronic device for generating a predetermined signal, comprising:
an operational circuit that generates the predetermined signal and outputs the predetermined signal;
a measuring section that measures a predetermined characteristic of the predetermined signal; and
the deterministic component model identifying apparatus as set forth in claim 1 that determines a model of a deterministic component contained in a probability density function of the characteristic measured by the measuring section and calculates the deterministic component.
